(19) United States
(12) Patent Application Publication
(10) Pub. No.: US 2008/0084039 A1
(43) Pub. Date: Apr. 10, 2008

(54) Bellman cart

(76) Inventor: Reynolds Ellsworth Moulton, Brooklyn, NY (US)

Correspondence Address: WILLIAM G. FELLOWS, 8610 SNOWDEN LOOP, LAUREL, MD, 20708, US

(21) Appl. No.: 11/545,967

(22) Filed: Oct. 10, 2006

(51) Int. Cl. B62B 3/00

(52) U.S. Cl. 280/47.35

(57) ABSTRACT

A Bellman cart has a base mounted with a flat rectangular platform and several brackets. A plurality of wheels connected to the base are coupled to an integrated steering mechanism provided with a steering wheel or slidable handgrips attached to the brackets and a drivetrain arranged beneath the platform. The steering wheel pulls the cable which is passed through the brackets and connected to a pulley in the drivetrain, to turn the pulley to drive a gear mounted below the pulley, to control the horizontal movement of a rod, connected to the wheels through a pivot, to control the pivotal movement of the wheels to regulate the movement and direction of the cart. Multiple mirrors are provided to present a clear view around the loaded objects. Multiple shock absorbers are provided in one embodiment to move the cart smoothly.

### A) TECHNICAL FIELD

The present invention generally relates to the cart devices, such as Bellman cart, porter cart, luggage cart, hotel cart, handcart, etc., used for transporting the luggages and personal items to the rooms in a service industry like the hotel, convention center etc. In particular this invention relates to a Bellman cart provided with a steering mechanism to simplify the maneuverability of the cart.

### B) BACKGROUND OF THE INVENTION

Bellman carts are used throughout the world to transport luggages, personal items, and goods to the rooms in a service industry such as hotel. The carts are used mainly in a service industry and they are most readily seen in hotels, airports and warehouses and convention centers to transport luggages and personal items. The currently available carts are difficult to maneuver. It is very difficult to control the movement and the direction the carts, especially when the carts are loaded with very heavy items. At present the movements of the carts are controlled by applying force to the back of the cart. In the hotel industry, the application of force to the back of the cart generates a potential danger and liability. The cart can go out of control potentially hitting objects and people. In addition the carts are difficult to control and maneuver around people, into elevators, around objects and around corners. Thus, there is a need for a steering mechanism to control and simplify the maneuverability of the cart.

The U.S. Pat. No. 5,826,892 discloses a push luggage cart, provided with a front steering roller and two rear support rollers. A hollow profiled connection section lockingly engages the connection units of the front and rear connecting units.

The U.S. Pat. No. 4,381,870 discloses a versatile cart device provided with a unique wheel structure to position the cart stably in an elevator.

The U.S. Pat. No. 5,964,471 discloses a steer able trolley provided with a steering mechanism having the communication elements installed between the driving and driven wheels so that the driving wheel is pivoted to a vertical axis to provide a vertical movement of the respective driven wheel.

The U.S. Pat. No. 5,082,074 discloses a transport vehicle provided with a driving wheel that is centrally and non-pivotably guided in a driving section. The driving wheel has an integrated mobile driving device to direct the cart in a desired direction

The U.S. Patent No. 2003 0071 426 discloses a cart moving system provided with an auxiliary wheel assembly mounted to the two frames provided in two different hand carts for moving large and bulky items easily over uneven surfaces.

The U.S. Patent No. 2005 0224 440 discloses a transportation cart used for animal barn and provided with ground wheels for supporting a frame over a ground surface so that one of the wheels is steered for directing the cart to the desired location. The front wheels are motor driven to transport heavy loads.

The U.S. Patent No. 2001 0018 993 discloses a motorized golf cart provided with a drive motor that is supported in a base frame and linked to a drive axle which selectively drives a pair of drive wheel hubs positioned at respective sides of the base frame.

Thus none of the above mentioned prior art devices are provided with a steering mechanism having a steering wheel or column to control the directional movement of the wheels on the cart. Hence, there is a need to develop a Bellman cart with a steering mechanism having a steering column or wheel to control and to simplify the maneuverability of the cart and to control the movement direction of the cart easily and efficiently.

A person pushing the cart cannot see the area at the sides and at the front of the cart, when the cart is loaded with heavy and large items. So, there is a need for providing a clear view of the area at the sides and at the front of the Bellman cart during the movement of the cart to move the cart easily around objects, persons, and around corners.

### C) OBJECTS OF THE INVENTION

The primary object of the invention is to provide an integrated steering mechanism to simplify and control the directional movement and the maneuverability of the cart.

Another object of the invention is to provide multiple mirrors to help the person operating the cart to see the areas at the sides and at the front of the cart.

Another object of the invention is to control the movement of the cart around objects, around persons, into elevators and at corners to avoid damage to the persons, thereby eliminating the generation of danger and liability due to the uncontrolled movement of the cart.

These and other objects and advantages of this invention will become readily apparent from the summary and the detailed description of the invention taken in conjunction with the accompanying drawings.

### D) SUMMARY OF THE INVENTION

According to one embodiment of this invention, a Bellman cart of this invention has a base mounted with a flat platform and several brackets that are provided with a support rod at both the ends. Pluralities of wheels are mounted at the bottom portion of the base. A steering mechanism integrally connected to the cart has a raised or elevated steering wheel provided at the backside of the cart and a drivetrain arranged beneath the platform. The steering wheel is attached to the brackets through a support frame provided between the brackets to control the movement and the direction of the cart. The drivetrain is provided with a pulley in which a gear is attached at the bottom, to control the movement of the rod that is connected pivotally to the wheels through a pivot. A cable, passed through the brackets and the support rods, is connected to the drivetrain through the pulley. The steering wheel pulls the cable to turn the pulley to drive the gear to control the movement and direction of the wheels thereby regulates the directional movement and control of the cart. Multiple mirrors or sensors are added to the cart to help the operating person to see the sides and the front of the cart clearly and easily and to avoid collision with the nearby objects.

In another embodiment of this invention, a set of slidable hand grips are provided in the bracket and are moved downwardly to pull the cable to control the movement of the wheels to regulate the movement and the direction of the cart.

The Bellman Cart usually has plurality of wheels. For example, in one embodiment of this invention the cart is provided with four wheels, while in another embodiments of the invention, the cart is provided with three wheels to carry lighter loads.

In one embodiment of this invention, the cart is provided with multiple shock absorbers to enable smooth movement of the Cart through uneven surfaces.

### E) BRIEF DESCRIPTION OF THE DRAWINGS

FIG. 1 shows the perspective view of a Bellman cart of the present invention in one embodiment.

FIG. 2 shows a partial front view of a drivetrain in one embodiment of the bellman cart represented in FIG. 1

FIG. 3 shows a perspective view of a bellman cart of this invention in another embodiment

FIG. 4 shows a partial front view of a drivetrain used in another embodiment of a bellman cart represented in FIG. 3

FIG. 5 shows a partial front view of the bracket provided with a slidable handgrip in another embodiment of a bellman cart represented in the FIG. 3.

### F) DETAILED DESCRIPTION OF THE PREFERRED OF EMBODIMENTS

In the following detailed description, a reference is made to the accompanying drawings. These embodiments are described with sufficient details to enable those skilled in the art to practice the embodiments and it is to be understood that logical, mechanical and other changes may be made without departing from the scope of the embodiments. Therefore the following detailed description is not to be taken in a limiting sense.

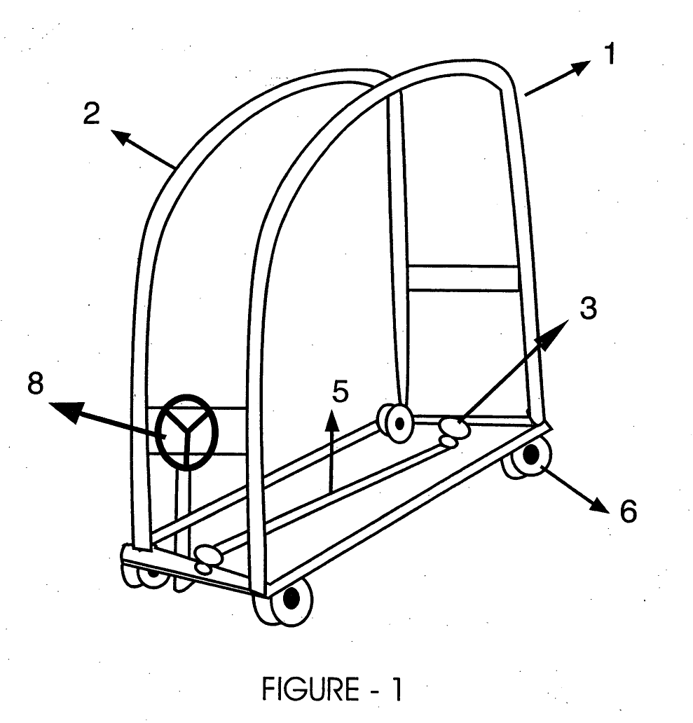

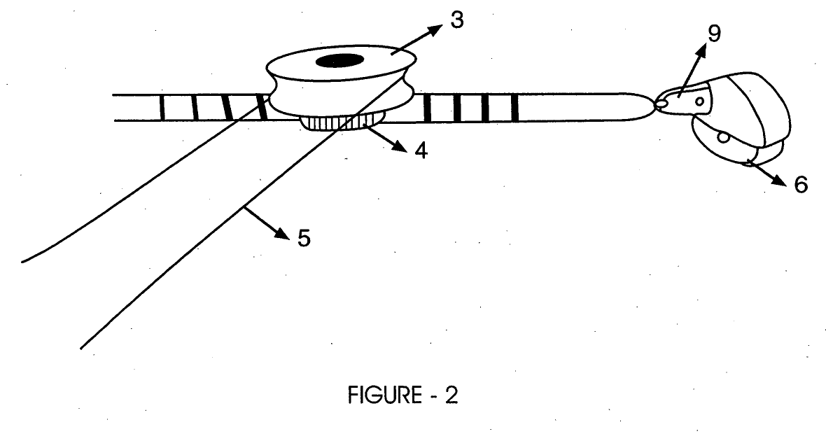

The FIG. 1 shows a perspective view of a bellman cart according to one embodiment of the present invention, while the FIG. 2 shows a partial front view of a drivetrain used in one embodiment a bellman cart represented in FIG. 1. With reference to the FIG. 1-2, the Bellman cart 1 has a base mounted with a flat platform. Plurality of wheels, for example four wheels 6 are attached to the bottom of the base. Several brackets 2 are mounted on the base. Each bracket 2 has a support rod provided at both the ends for stability. The integrated steering mechanism connected to the wheels 6 of the Bellman cart 1 has a steering wheel 7 and a drivetrain. The drivetrain is arranged beneath the platform. The drivetrain is provided with a pulley 3 in which a gear 4 is attached below to control the horizontal movement of a rod that is connected pivotally to the wheels 6 through a pivot 9 so that the pivot point is arranged in front of the center of the wheels 6 to enable the steering of the cart by a steering wheel 7. The steering wheel 7 is provided at the backside of the cart in a raised condition and is connected to the brackets 2 through a support frame provided between the support rods in the brackets 2. A cable 5, which is passed through the support rods and the brackets 2, is connected to the drivetrain through the pulley 3. The steering wheel 7 is moved to pull the cable 5 to turn a pulley 3 to drive the gear 4 to control the horizontal movement of the rod between the wheels 6 to control the movement and the direction of the wheels 6 to control the movement and the direction of the bellman cart 1.

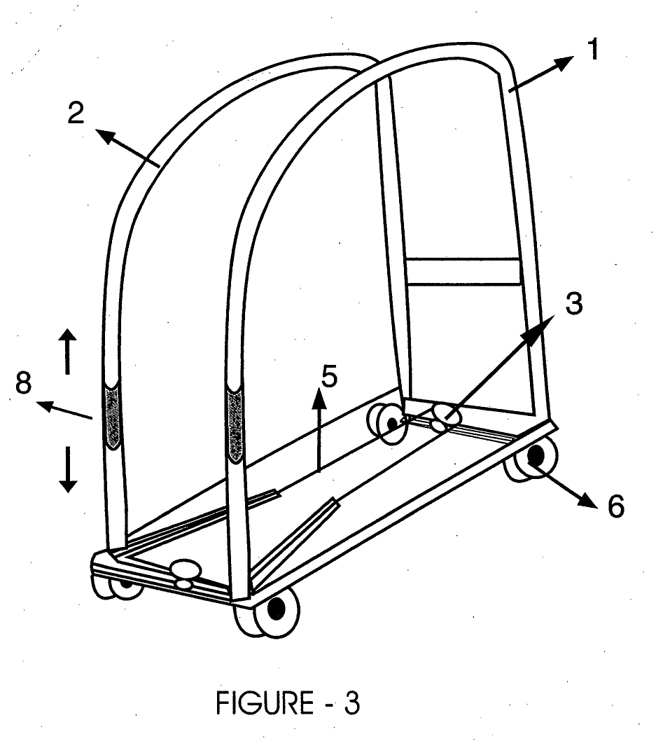

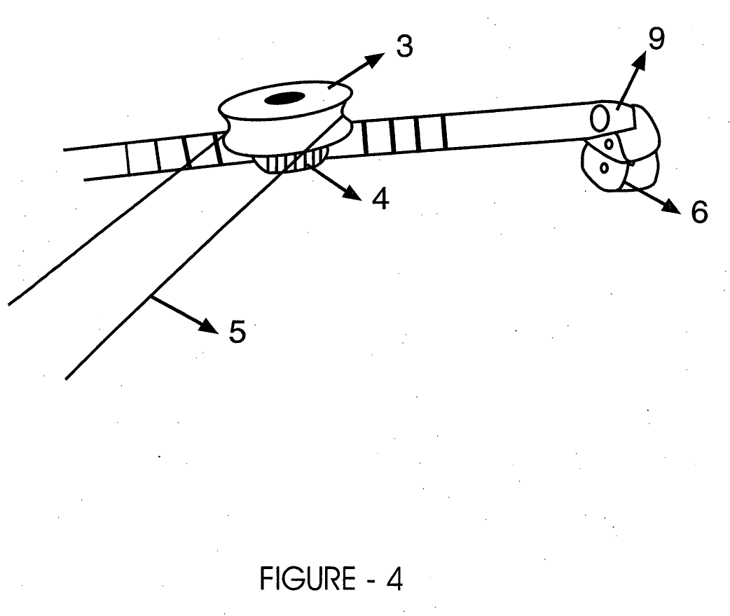

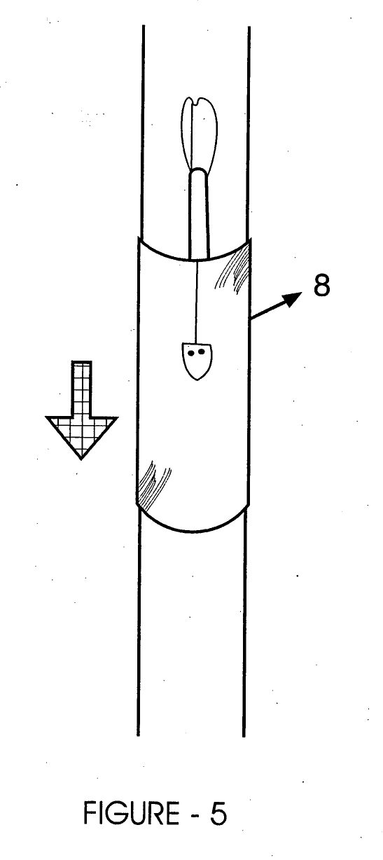

As shown in FIG. 3-FIG. 5, an another embodiment of the bellman cart 1 of the present invention has a slidable hand grip 8 provided at the brackets 2 so that the hand grip 8 is slid downwardly to activate the movement of the cables 5 connected to the drivetrain to control the directional movement of the wheels 6 and thereby controlling the movement of the cart 1.

In one embodiment of the present invention, the platform is formed in rectangular shape to provide maximum balance for the heavy load. The rectangular shape also permits the cart to go through narrow spaces and enables to steer the cart easily. In another embodiment of this invention, the platform is formed in a polygon shape. The platform may be made up of any sturdy, hard material having sufficient strength to hold maximum load. In a preferred embodiment of this invention, the flat platform is made up of metals and covered with a protective layer to prevent damage to the platform due to frequent loading and unloading of heavy materials.

The brackets 2 mounted on the base of the cart may be formed in the several shapes. In one embodiment of the present invention, multiple mirrors are provided at the sides or at the top of the cart to enable an operator of the cart to see around large objects that are loaded on the cart for transportation.

In another embodiment of the present invention, a sensor is provided in the cart to detect the presence of the objects along the movement direction and path to output an alarm such as beep sound, signal, light, etc., to alert the operator of the cart regarding the presence of objects along the movement path, thereby enabling the operator of the cart to avoid collisions with the objects on the movement path and to avoid damage and liability due to uncontrolled movement of the cart.

In yet another embodiments of this invention, multiple shock absorbers are provided in the cart to move the cart smoothly on the uneven floors.

In yet another embodiment of this invention, the steering wheels are provided at the front and at the back of the cart to control the movement of the drive train to enable the maneuverability of the cart in both the directions and hence achieve smooth and even directional movement of the cart.

Thus the present invention provides a steering mechanism to control and simplify the maneuverability of the Bellman cart easily and efficiently. This invention helps to maneuver the cart easily and efficiently around objects, corners and persons and into elevators thereby eliminating the generation of potential loss and danger.

It will be obvious for a person skilled in the art to practice the invention with further modifications. However, all those modifications will be deemed to be covered within the scope of the invention as covered in the claims mentioned here under.

What is claimed is:

1. A bellman cart, comprising:
a) a base having a flat platform;
b) a plurality of bracket members provided with support rods at both ends and mounted on the base;
c) a plurality of wheels attached to the base, and
d) a steering mechanism coupled to the wheels, wherein, the steering mechanism comprises a drivetrain provided beneath the base, and a steering wheel attached to the bracket members and connected to the drivetrain to control movement of the wheels.

2. A bellman cart according to claim 1, wherein the drivetrain has a pulley with a gear.

3. A bellman cart according to claim 2, further comprising a cable that passes through the bracket members and the support rods.

4. A bellman cart according to claim 3, wherein the cable is connected between the steering wheel and the pulley.

5. A bellman cart according to claim 1, wherein the steering wheel is attached to the support rods of the bracket members by a support member that is connected between the bracket members.

6. A bellman cart according to claim 1, wherein the steering wheel is attached to the bracket members in a raised or elevated condition.

7. A bellman cart according to claim 1, wherein the steering wheel is provided at a back end of the cart.

8. A bellman cart according to claim 4, and further comprising a steering rod connected to the wheels through a pivot, the steering rod having teeth in which the gear engages, the steering wheel being operable to pull the cable to turn the pulley and the gear to control horizontal movement of the steering rod, to thereby control pivotal movement of the wheels to regulate movement direction of the cart.

9. A bellman cart according to claim.1, wherein the flat platform is polygonal.

10. A bellman cart according to claim 9, wherein the flat platform is rectangular.

11. A bellman cart according to claim 1, wherein the platform is made of a rigid material.

12. A bellman cart according to claim 11, wherein the platform is made of metal covered by a protective layer.

13. A bellman cart according to claim.1, further comprising multiple mirrors arranged to provide a clear view around the objects loaded on the platform.

14. A bellman cart, comprising:
a) a base having a flat platform;
b) a plurality of bracket members provided with support rods at both ends and mounted on the base;
c) a plurality of wheels attached to the base, and
d) a steering mechanism coupled to the wheels, wherein the steering mechanism comprises; a drivetrain provided beneath the base, and a slidable handgrip provided at the bracket members and connected to the drivetrain to control movement of the wheels.

15. A bellman cart according to claim 14, wherein the drivetrain has a pulley with a gear.

16. A bellman cart according to claim 15, further comprising a cable that is passes through the bracket members and the support rods.

17. A bellman cart according to claim 16, wherein the cable is connected between the handgrip and the pulley.

18. A bellman cart according to claim 17, wherein the slidable handgrip is provided at the bracket members in an elevated or raised condition.

19. A bellman cart according to claim 18, wherein the slidable handgrip is provided at a back end of the cart.

20. A bellman cart according to claim 14, and further comprising a steering rod connected to the wheels through a pivot, the steering rod having teeth in which the gear engages, the slidable hand grip being operable to pull the cable to turn the pulley and the gear to control horizontal movement of the steering rod, to thereby control pivotal movement of the wheels to regulate movement direction of the cart.

21. A bellman cart according to claim 14, wherein the flat platform is polygonal.

22. A bellman cart according to claim 21, wherein the flat platform is rectangular.

23. A bellman cart according to claim 14, wherein the platform is made of material.

24. A bellman cart according to claim 23, wherein the platform is made of metal covered by a protective layer.

25. A bellman cart according to claim 14, further comprising multiple mirrors provided at the sides or at the top to provide a clear view around objects loaded on the platform.

26. A bellman cart, according to claim 4, wherein,
i) the steering mechanism further comprises
a second steering wheels attached to the bracket members and connected to the drivetrain to control the movement of the wheels.

25. A Bellman cart according to claim.24, wherein the drivetrain has a pulley mounted with a gear at the bottom.

26. A Bellman cart according to claim.24, further comprising a cable that is passed through the bracket members and the support rods.

27. A Bellman cart according to claim 26, wherein the cable is connected to the drivetrain through the pulley.

27. A Bellman cart according to claim 26, wherein the two steering wheels are attached to the support rods of the bracket members through a by respective members connected between the bracket members.

28. A bellman cart according to claim 26, wherein the two steering wheels are attached to the bracket members in a raised or elevated condition

29. A bellman cart according to claim 26, wherein the two steering wheels are provided respectively at a front and a back of the cart.

30. A bellman cart according to claim 26, wherein each steering wheel is operatable to pull the cable to turn the pulley and the gear to control horizontal movement of the steering rod, to thereby control pivotal movement of the wheels to regulate movement direction of the cart.

32. A Bellman cart according to claim 24, wherein the flat platform is polygonal in shape.

33. A Bellman cart according to claim 32, wherein the flat platform is rectangular in shape.

34. A Bellman cart according to claim 24, wherein the flat platform is rectangular in shape.

35. A Bellman cart according to claim 24, wherein the platform may be made of any sturdy, hard material preferably a metal and covered with a protective layer.

36. A Bellman cart according to claim 24, further comprising multiple mirrors provided at the sides or at the top to provide a clear view around the objects loaded on the platform.

37. A Bellman cart, comprising:
j) A base mounted with a flat platform;
k) A plurality of bracket members provided with support rods at both ends and mounted on the base;
l) A plurality of wheels attached to the bottom of the base; and
m) A steering mechanism coupled to the wheels,
n) Wherein, the steering mechanism comprising;
(i) A drivetrain provided beneath the base; and
(ii) A steering wheel attached to the bracket members and connected to the drive train to control the movement of the wheels.

38. A Bellman cart according to claim 37, wherein the drivetrain has a pulley mounted with a gear at the bottom.

39. A Bellman cart according to claim 37, further comprising a cable that is passed through the bracket members and the support rods.

40. A Bellman cart according to claim 39, wherein the cable is connected to the drivetrain through the pulley.

41. A Bellman cart according to claim 37, wherein the steering wheel is attached to the support rods of the bracket members through a support frame that is provided between the bracket members.

42. A Bellman cart according to claim 37, wherein the steering wheel is attached to the bracket members in a raised or elevated condition.

43. A Bellman cart according to claim 37, wherein the steering wheel is provided at the back.

44. A Bellman cart according to claim 37, wherein the steering wheel is operated to pull the cable to turn the pulley to drive the gear to control the horizontal movement of a rod, which is connected to the wheels through a pivot, to control the pivotal movement of the wheels to regulate the movement direction.

45. A Bellman cart according to claim 37, wherein the flat platform is polygonal in shape.

46. A Bellman cart according to claim 45, wherein the flat platform is rectangular in shape.

47. A Bellman cart according to claim 37, wherein the platform may be made of any sturdy, hard material preferably a metal and covered with a protective layer.

48. A Bellman cart according to claim 37, further comprising multiple mirrors provided at the sides or at the top to provide a clear view around the objects loaded on the platform.

31. A bellman cart according to claim 1, further comprising shock absorbers attached to.
